(19) United States
(12) Patent Application Publication
(10) Pub. No.: US 2013/0030695 A1
(43) Pub. Date: Jan. 31, 2013

(54) MAP DIFFERENCE DATA DISTRIBUTION SYSTEM, MAP DIFFERENCE DATA DISTRIBUTION APPARATUS, AND MAP DIFFERENCE DATA DISTRIBUTION METHOD

(71) Applicants: Toshio Nomura, Chiryu-city (JP); Takamitsu Suzuki, Okazaki-city (JP)

(72) Inventors: Toshio Nomura, Chiryu-city (JP); Takamitsu Suzuki, Okazaki-city (JP)

(73) Assignee: DENSO CORPORATION, Kariya-city (JP)

(21) Appl. No.: 13/550,672

(22) Filed: Jul. 17, 2012

(30) Foreign Application Priority Data
Jul. 27, 2011 (JP) 2011-164365

(51) Int. Cl. G01C 21/34

(52) U.S. Cl. 701/420

(57) ABSTRACT

An in-vehicle navigation apparatus transmits a present position, a destination, and a version number of in-vehicle map data stored in an in-vehicle map storage portion to a map difference data distribution apparatus. The map difference data distribution apparatus calculates a route from the present position and destination received from the in-vehicle navigation apparatus, compares a version number of map data stored in a center map storage portion with the received version number of the in-vehicle map data to prepare map difference data of map elements contained in the route, and distributes the prepared map difference data to the in-vehicle navigation apparatus.

### CROSS REFERENCE TO RELATED APPLICATION

This application is based on Japanese Patent Application No. 2011-164365 filed on Jul. 27, 2011, the disclosure of which is incorporated herein by reference.

### TECHNICAL FIELD

The present disclosure relates to a map difference data distribution system that distributes map difference data from a map difference data distribution apparatus to an in-vehicle navigation apparatus, a map difference data distribution apparatus that distributes map difference data to an in-vehicle navigation apparatus, and a map difference data distribution method.

### BACKGROUND

[Patent document 1] JP 2008-249798 A (US 2010/0030460 A)

There is conventionally existing a map difference data distribution apparatus, which prepares map difference data between the map data before an update and the map data after the update to thereby distribute the prepared map difference data to an in-vehicle navigation apparatus, when such an update takes place according to an instruction of adding or deleting map elements such as roads in the map data. For example, Patent document 1 discloses a technology, which prepares the map difference data relative to each division unit and distributes the prepared map difference data to an in-vehicle navigation apparatus.

Such a system, which distributes map difference data from the map difference data distribution apparatus to the in-vehicle navigation apparatus, is designed to predetermine a target area of which map difference data is distributed. Such a target area may not be associated with an actually traveling area of a user. For example, narrow streets in a distant area that is more than a predetermined first distance (e.g., 10 km) far from home are not regarded as an update target; any roads in a more distant area that is more than a predetermined second distance (e.g., 80 km) far from home are not regarded as an update target.

### SUMMARY

The present disclosure is made in view of the above-mentioned situation. It is an object of the present disclosure to provide a map difference data distribution system, a map difference data distribution apparatus, and a map difference data distribution method, which provide map difference data suitable for an actual travel of a user.

To achieve the above object, according to a first example of the present disclosure, a map difference data distribution system is provided to include an in-vehicle navigation apparatus in a vehicle, and a map difference data distribution apparatus that is separated from the vehicle. The in-vehicle navigation apparatus includes an in-vehicle map storage portion to store in-vehicle map data. The in-vehicle navigation apparatus transmits a present position of the vehicle, a destination of the vehicle, and a version number of the in-vehicle map data in the in-vehicle map storage portion, to the map difference data distribution apparatus. The map difference data distribution apparatus includes a center map storage portion to store center-side map data. The map difference data distribution apparatus calculates a route from the present position and the destination received from the in-vehicle navigation apparatus based on the center-side map data stored in the center map data portion, compares a version number of the center-side map data stored in the center map storage portion with the version number of the in-vehicle map data in the in-vehicle map storage portion, and prepares map difference data of map elements contained in the calculated route. The map difference data distribution apparatus further distributes the prepared map difference data to the in-vehicle navigation apparatus.

The above configuration is different from a conventional configuration in which a target area for map difference data distributed from a map difference data distribution apparatus to an in-vehicle navigation apparatus is previously determined. Thus, unlike the conventional configuration, when map elements contained in a route from a present position to a destination are updated, the map difference data of map elements contained in the route can be distributed from the map difference data distribution apparatus to the in-vehicle navigation apparatus. This configuration can provide the map difference data suitable for an actual travel of a user.

Further, according to a second example of the present disclosure, a map difference data distribution apparatus separate from a vehicle is provided as follows. The map difference data distribution apparatus includes: a reception portion to receive a present position of the vehicle, a destination of the vehicle, and a version number of in-vehicle map data stored in the vehicle, from an in-vehicle navigation apparatus in the vehicle; a center map storage portion to store center-side map data; a route calculation section to calculate a route from the present position and the destination received from the in-vehicle navigation apparatus based on the center-side map data stored in the center map storage portion; a map difference data preparation section to compare a version number of the center-side map data stored in the center map storage portion with the received version number of the in-vehicle map data, and prepare map difference data of map elements contained in the calculated route; and a distribution portion to distribute the map difference data prepared by the map difference data preparation section to the in-vehicle navigation apparatus.

Yet further, according to a third example, a map difference data distribution method performed in an in-vehicle navigation apparatus and a map difference data distribution apparatus is provided as follows. The in-vehicle navigation apparatus is in a vehicle; the map difference data distribution apparatus is separate from the vehicle. The method is computer-implemented. The method includes: transmitting a present position of the vehicle, a destination, and a version number of an in-vehicle map data from the in-vehicle navigation apparatus to the map difference data distribution apparatus; calculating a route based on the present position and destination, which are received from the in-vehicle navigation apparatus, in the map difference data distribution apparatus having center-side map data; comparing a version number of the center-side map data with the version number of the in-vehicle map data, which is received from the in-vehicle navigation apparatus, in the map difference data distribution apparatus; preparing map difference data of map elements contained in the calculated route in the map difference data distribution apparatus; and distributing the prepared map difference data from the map difference data distribution apparatus to the in-vehicle navigation apparatus.

The above configuration of the second and third examples can provide an advantage similar to that of the first example.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a functional block diagram according to an embodiment of the present disclosure;

FIG. 2 is a sequence diagram;

FIGS. 3A, 3B are diagrams illustrating map difference data; and

FIGS. 4A, 4B are other diagrams illustrating map difference data.

### DETAILED DESCRIPTION

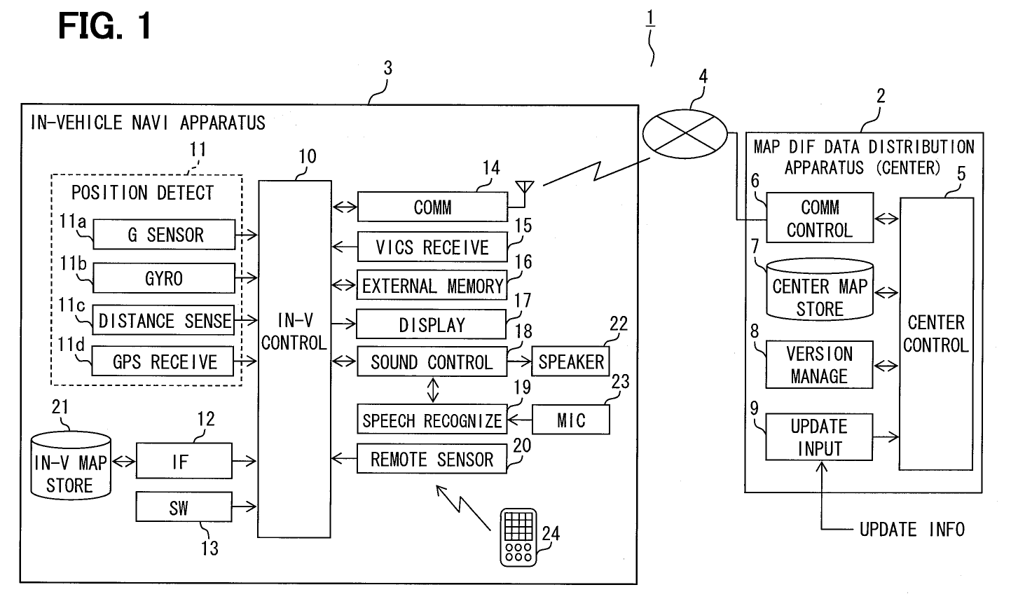

An embodiment according to the present disclosure will be explained with reference to drawings. FIG. 1 illustrates an overall configuration of a map difference data distribution system 1 according to an embodiment of the present disclosure. In the map difference data distribution system 1, a map difference data distribution apparatus (also referred to as a center) 2 which distributes map difference data and an in-vehicle navigation apparatus 3 which receives map data distributed from the map difference data distribution apparatus 2 are communicated with each other via a communication network 4. The communication network 4 includes a fixed-line communication network and a mobile communication network.

The map difference data distribution apparatus 2 includes the following: a controller 5 (also referred to as a center controller, a route calculation section, device, or means, and a map difference data preparation section, device, or means); a communication controller 6 (also referred to as a reception portion, device, or means, and a distribution portion, device, or means); a center map storage portion 7 (also referred to as a map storage portion, device, or means) to store map database; a map version management portion 8 to manage a map data version number; and a map update input portion 9 to input or receive map update information.

The controller 5 includes a known micro-computer having a CPU, RAM, ROM, I/O bus, etc., and controls an overall operation of the map difference data distribution apparatus 2 such as a communication operation and a data management operation. The communication controller 6 controls a wide area communication operation with the communication network 4. The center map storage portion 7 stores the map database containing map data (i.e., center-side map data) which indicate an arrangement of map elements. The map elements include roads and intersections as units. The map version management portion 8 manages a version number (i.e., version) of the map data stored in the center map storage portion 7. The map update input portion 9 is used for inputting map update information which requests an update (i.e., addition or deletion) of map elements with respect to the map data from an outside source. That is, according to an update event such as an open or closure of a road, an operator in the center manipulates a manipulation portion such as a keyboard or mouse, thereby inputting the map update information into the map update input portion 9, for instance. For example, when the map update input portion 9 receives map update information which requests an addition of a map element according to an open of a road, the controller 5 reflects the addition of the map element on newest map data stored in the map storage portion 7. Further, when the map update input portion 9 receives map update information which requests a deletion of a map element according to a closure of a road, the controller 5 reflects the deletion of the map element on newest map data stored in the map storage portion 7. Thereby, the controller 5 prepares the map data, on which the addition or deletion of the map element is reflected, as map data having a new version number, and stores the prepared map data with the new version number in the map storage portion 7. Moreover, each time storing the map data with the new version number in the map storage portion 7 (i.e., updating the map data in the storage portion), the controller 5 manages the new version number of the map data using the map version management portion 8.

The in-vehicle navigation apparatus 3 includes the following: an in-vehicle controller 10; a position detection portion 11; a map data input/output portion 12; a manipulation switch group 13; a communication portion 14; a VICS (Vehicle Information Communication System, registered trademark) receiver 15; an external memory 16; a display portion 17; a sound controller 18; a speech recognition portion 19; and a remote control sensor 20.

The controller 10 includes a known micro-computer having a CPU, RAM, ROM, I/O bus, etc., and controls an overall operation of the in-vehicle navigation apparatus 3 such as a communication operation and a data management operation. The position detection portion 11 includes a G sensor 11a, a gyroscope 11b, a distance sensor 11c, and a GPS (Global Positioning System) receiver 11d. The sensors or the like 11a to 11d of the position detection portion 11 individually have different types of detection errors from each other. The controller 10 complements detection signals inputted from these sensors or the like with each other to thereby detect or designate a present position of the vehicle. In addition, the position detection portion 11 may not need all the sensors or the like, depending on required detection accuracy. Moreover, the position detection portion 11 may further include a steering sensor for detecting a steering angle, and a wheel sensor for detecting rotation of wheels.

The map data input/output portion 12 reads or writes the map data (in-vehicle map data) in the map storage portion 21 composed of a storage media such as a HDD. The manipulation switch group 13 includes a mechanical key which is arranged around the display portion 17 or a touch-sensitive key which is formed on a display screen of the display portion 17. The manipulation switch group 13 detects a user's manipulation to thereby output a corresponding manipulation detection instruction or signal to the controller 10.

The communication controller 14 controls a wide area communication operation with the communication network 4. The VICS receiver 15 receives VICS information transmitted from a VICS distribution center (not shown). The external memory 16 includes a high-capacity storage unit such as a HDD. The display portion 17 includes, for example, a liquid crystal display. The display portion 17 displays various kinds of display windows, such as a menu window and destination designation window while superimposing a present position mark for indicating a present position of the vehicle, a vehicular swept path, and the like on a map generated from map data. In addition, the display portion 17 may include an organic electroluminescence (EL) or a plasma display.

The sound controller 18 controls the speech recognition portion 19 and outputs, for example, a route guidance message, a warning message via the speaker 22. The speech recognition portion 19 performs speech recognition of sounds or speeches inputted via the microphone 23 based on a speech-recognition algorithm. The remote control sensor 20 receives a manipulation detection signal transmitted from a remote control 24, detects a corresponding manipulation instruction executed by an occupant of the vehicle via the remote control 24, and outputs a manipulation detection signal indicating the manipulation instruction to the controller 10.

The controller 10 has known functions for navigating the vehicle as follows: a map matching function performing a map matching process to designate a road where the present position of the vehicle is located by using road data included in the map data and the detected present position of the vehicle; a route retrieval function retrieving a route to a destination designated by an occupant of the vehicle from the present position designated by the map matching process; a route guidance function performing route guidance by calculating a point required for route guidance based on road data and positions of intersections contained in the map data, and retrieved route; and an image rendering function rendering a peripheral map around a present position of the vehicle, a schematic drawing of a highway, and an enlarged view near an intersection.

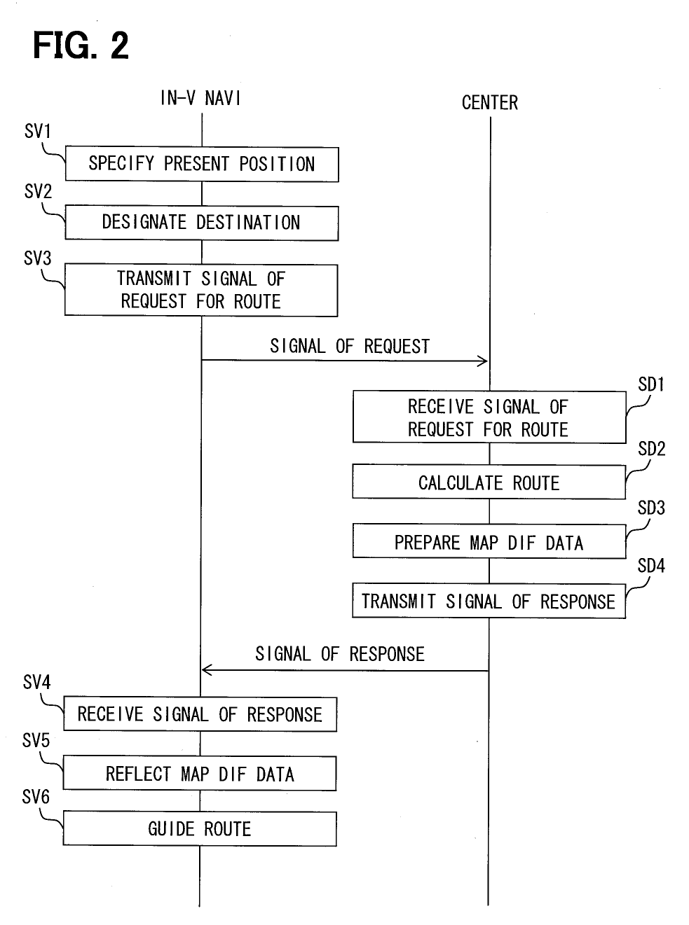

The following will explain an operation executed by the controller 10 of the in-vehicle navigation apparatus 3 and the controller 5 of the map difference data distribution apparatus 2 under the above mentioned configuration with reference to FIGS. 2, 3A, 3B, 4A, 4B.

It is further noted that a sequence, flowchart, or the processing of the sequence or flowchart in the present application includes sections (also referred to as steps), which are represented, for instance, as SV1 or SD1. Further, each section can be divided into several sub-sections while several sections can be combined into a single section. Furthermore, each of thus configured sections can be referred to as a device, module, or means and achieved not only (i) as a software section in combination with a hardware unit (e.g., computer), but also (ii) as a hardware section, including or not including a function of a related apparatus. Further, the hardware section may be inside of a microcomputer.

The in-vehicle controller 10 of the navigation apparatus 3 executes the processing at SV1 to SV6, whereas the center controller 5 of the map difference data distribution apparatus 2 executes the processing at SD1 to SD4. At SV1, the in-vehicle controller 10 specifies a present position of the vehicle periodically by complementing mutually detection signals inputted from each sensor or the like of the position detection portion 11. At SV2, a destination is designated by user's manipulating the manipulation switch group 13. At SV3, a route calculation request signal is prepared which contains the newest present position, the destination, the newest version number of the map data stored in the in-vehicle map storage portion 21, and an apparatus ID (user ID) that can identify the in-vehicle navigation apparatus 3; then, the prepared route calculation request is transmitted from the communication portion 14 to the map difference data distribution apparatus 2 via the communication network 4.

Subsequently, the center controller 5 in the map difference data distribution apparatus 2 executes as follows. At SD1, the route calculation request signal from the in-vehicle navigation apparatus 3 is received using the communication controller 6 via the communication network 4; then, the present position and the destination of the vehicle are extracted from the route calculation request signal, and a route from the present position to the destination is calculated with reference to the map data stored in the center map storage portion 7. At SD3, a map difference data is prepared as follows. That is, the controller 5 extracts the version number of the in-vehicle map data from the route calculation request signal, and compares the version number of the extracted in-vehicle map data, which is stored in the in-vehicle navigation apparatus 3 (i.e., in the in-vehicle map storage portion 21), with the version number of the center-side map data stored in the center map storage portion 7, thereby preparing the map difference data. After the center-side map data stored in the center map storage portion 7 in the map difference data distribution apparatus 2 is updated, the updated data may be distributed to the in-vehicle navigation apparatus 3 from the map difference data distribution apparatus 2. In this case, the version number of the center-side map data stored in the center map storage portion 7 is equal to the version number of the in-vehicle map data in the in-vehicle navigation apparatus 3. In contrast, the updated data may not be distributed to the in-vehicle navigation apparatus 3 from the map difference data distribution apparatus 2. In this case, the version number of the center-side map data stored in the center map storage portion 7 is newer (has a greater version number) than the version number of the in-vehicle map data in the in-vehicle navigation apparatus 3.

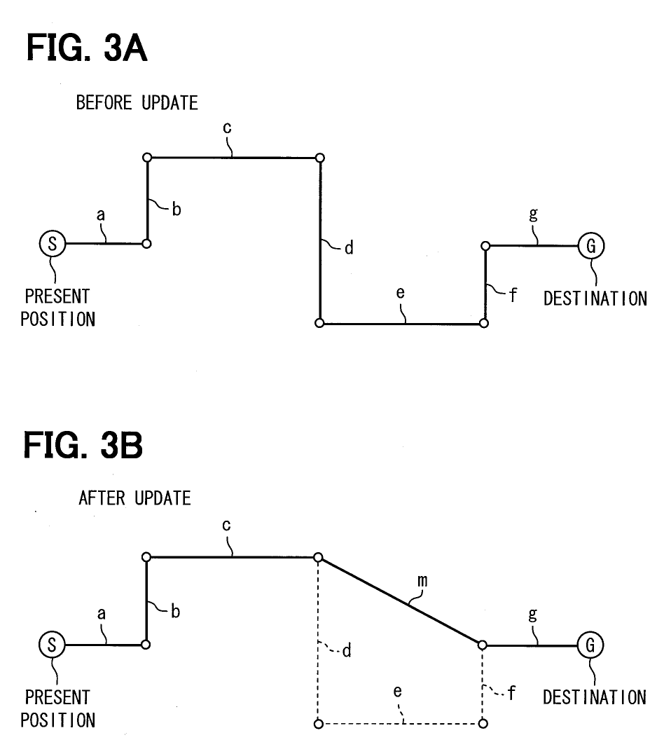

The following will explain a procedure executed by the center controller 5 to prepare map difference data. A first route is calculated from the present position to the destination based on the version number of the in-vehicle map data extracted from the route calculation request signal transmitted from the in-vehicle navigation apparatus 3. For instance, the first route goes from the present position as a start position to the destination as a goal position via roads or road segments “a”, “b”, “c”, “d”, “e”, “f”, and “g”, as illustrated in FIG. 3A. A second route is calculated from the present position to the destination based on the version number of the center-side map data stored in the center map storage portion 7. For instance, the second route goes via the roads or road segments “a”, “b”, “c”, “m”, and “g”, as illustrated in FIG. 3B. In this case, there is a difference between the first route and the second route. Thus, it is determined that the in-vehicle map data stored in the in-vehicle navigation apparatus 3 is not the newest map data. Map difference data are prepared which indicate that the road segments “d”, “e”, and “f” are replaced with the road segment “m”, or that the road segments “d”, “e”, and “f” is closed and the road segment “m” is opened.

The center controller 5 prepares the route calculation reply signal containing the calculated route and the map difference data, and transmits the prepared route calculation reply signal from the communication controller 6 to the in-vehicle navigation apparatus 3 via the communication network 4 (SD4).

Subsequently, in the in-vehicle navigation apparatus 3, the in-vehicle controller operates as follows. The route calculation reply signal from the map difference data distribution apparatus 2 is received using the communication portion 14 via the communication network 4 (SV4). The map difference data is extracted from the route calculation reply signal, and the extracted map difference data is reflected on the in-vehicle map data stored in the map storage portion 21 (SV5). A route guidance is performed according to the route transmitted from the map difference data distribution apparatus 2 (SV6). In the example illustrated in FIGS. 3A, 3B, the in-vehicle controller 10 performs a route guidance along the second route that passes through the road segments “a”, “b”, “c”, “m”, and “g”, which are transmitted from the map difference data distribution apparatus 2, instead of the first route that passes through the road segments “a”, “b”, “c”, “d”, “e”, “f”, and “g”, which are calculated based on the in-vehicle map data stored in the in-vehicle map storage portion 21 before transmitting the route calculation request signal to the map difference data distribution apparatus 2.

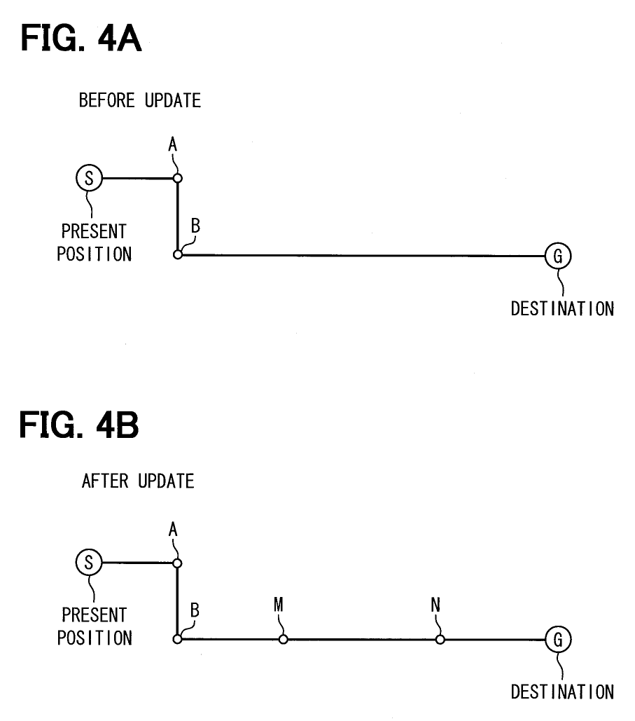

In the above explanation, the update of map data is made with respect to a road or road segment serving as a map element. Naturally, an update of map data may be made with respect to an intersection serving as a map element. That is, the center controller 5 calculates a first route from the present position to the destination based on the version number of the in-vehicle map data extracted from the route calculation request signal transmitted from the in-vehicle navigation apparatus 3. For instance, the first route passes through intersections “A” and “B”, as illustrated in FIG. 4A. A second route is calculated from the present position to the destination based on the version number of the center map data stored in the center map storage portion 7. For instance, the second route passes through intersections “A”, “B”, “M”, and “N” as illustrated in FIG. 4B. In this case, there is a difference between the first route and the second route in the map elements of the intersections. Thus, it is determined that the in-vehicle map data stored in the in-vehicle navigation apparatus 3 is not the newest map data. Map difference data are prepared which indicate that the intersections “M” and “N” are added. Moreover, there may be a case that types of traffic signals or traffic signs are changed or updated in the route from the present position to the destination. In such a case, map difference data may be prepared similarly. Furthermore, there may be a case that all or some of a road, an intersection, a type of traffic signal, and a traffic sign are changed or updated in combination simultaneously. Even in such a case, map difference data may be prepared similarly.

As explained above, according to the present embodiment, in the in-vehicle navigation apparatus 3, a present position, a destination, and a version number of in-vehicle map data stored in the in-vehicle map storage portion 21 are transmitted to the map difference data distribution apparatus 2. Subsequently, in the map difference data distribution apparatus 2, a route is calculated from the present position and the destination received from the in-vehicle navigation apparatus 3; further, a version number of the center-side map data stored in the center map storage portion 7 is compared with the received version number of the in-vehicle map data in the in-vehicle navigation apparatus 3. Thereby, map difference data of map elements contained in the calculated route is prepared and distributed to the in-vehicle navigation apparatus 3.

Herein, for instance, the map elements contained in the route include a road (or road segment) or an intersection. Further, in other words, the map elements contained in the route include a road (or road segment) or an intersection, which is a difference between the center-side map data and the in-vehicle map data.

In a conventional technology, a target area for map difference data distributed from a map difference data distribution apparatus to an in-vehicle navigation apparatus is previously determined. The present embodiment uses a manner different from such a conventional manner. That is, the map difference data of map elements contained in the route are distributed from the map difference data distribution apparatus 2 to the in-vehicle navigation apparatus 3. This configuration can provide the map difference data suitable for an actual travel of a user.

The present disclosure is not limited only to the above-mentioned embodiment, and can be modified or extended as follows. Designation of a destination is made by a user manipulating the manipulation switch group 13. Without need to be limited thereto, it may be made using the speech recognition.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A map difference data distribution system comprising:
an in-vehicle navigation apparatus in a vehicle; and
a map difference data distribution apparatus that is separated from the vehicle,
the in-vehicle navigation apparatus including an in-vehicle map storage portion to store in-vehicle map data,
the in-vehicle navigation apparatus transmitting a present position of the vehicle, a destination of the vehicle, and a version number of the in-vehicle map data in the in-vehicle map storage portion, to the map difference data distribution apparatus,
the map difference data distribution apparatus including a center map storage portion to store center-side map data,
the map difference data distribution apparatus
calculating a route from the present position and the destination received from the in-vehicle navigation apparatus based on the center-side map data stored in the center map data portion,
comparing a version number of the center-side map data stored in the center map storage portion with the version number of the in-vehicle map data in the in-vehicle map storage portion, and
preparing map difference data of map elements contained in the calculated route,
the map difference data distribution apparatus further distributing the prepared map difference data to the in-vehicle navigation apparatus.

2. The map difference data system according to claim 1, wherein:
the in-vehicle navigation apparatus reflects the map difference data received from the map difference data distribution apparatus on the in-vehicle map data in the in-vehicle map storage portion, and provides a route guidance from the present position to the destination based on the in-vehicle map data on which the map difference data are reflected.

3. The map difference data system according to claim 1, wherein:
the map difference data distribution apparatus prepares the map difference data of map elements that include a road.

4. The map difference data distribution system according to claim 1, wherein:
the map difference data distribution apparatus prepares the map difference data of map elements that include at least one of a road and an intersection.

5. The map difference data distribution system according to claim 1, wherein:
the map difference data distribution apparatus prepares the map difference data of map elements including at least one of a road and an intersection, the at least one of the road and the intersection being a difference between
a route that is calculated from the present position to the destination based on the center-side map data and
a route that is calculated from the present position to the destination based on the in-vehicle map data.

6. A map difference data distribution apparatus that is separate from a vehicle, the map difference data distribution apparatus comprising:
a reception portion to receive a present position of the vehicle, a destination of the vehicle, and a version number of in-vehicle map data stored in the vehicle, from an in-vehicle navigation apparatus in the vehicle;
a center map storage portion to store center-side map data;
a route calculation section to calculate a route from the present position and the destination received from the in-vehicle navigation apparatus based on the center-side map data stored in the center map storage portion;
a map difference data preparation section to
compare a version number of the center-side map data stored in the center map storage portion with the received version number of the in-vehicle map data, and
prepare map difference data of map elements contained in the calculated route; and
a distribution portion to distribute the map difference data prepared by the map difference data preparation section to the in-vehicle navigation apparatus.

7. A map difference data distribution method performed in an in-vehicle navigation apparatus and a map difference data distribution apparatus, the in-vehicle navigation apparatus being in a vehicle, the map difference data distribution apparatus being separate from the vehicle, the method being computer-implemented,
the method comprising:
transmitting a present position of the vehicle, a destination, and a version number of an in-vehicle map data from the in-vehicle navigation apparatus to the map difference data distribution apparatus;
calculating a route based on the present position and destination, which are received from the in-vehicle navigation apparatus, in the map difference data distribution apparatus having center-side map data;
comparing a version number of the center-side map data with the version number of the in-vehicle map data, which is received from the in-vehicle navigation apparatus, in the map difference data distribution apparatus;
preparing map difference data of map elements contained in the calculated route in the map difference data distribution apparatus; and
distributing the prepared map difference data from the map difference data distribution apparatus to the in-vehicle navigation apparatus.
